(19) United States
(12) Patent Application Publication
(10) Pub. No.: US 2009/0049096 A1
(43) Pub. Date: Feb. 19, 2009

(54) Multimedia storage media with playback function and multimedia player with modeling-looking

(76) Inventor: Chu-Hsin Peng, Taipei County (TW)

Correspondence Address: BIRCH STEWART KOLASCH & BIRCH, PO BOX 747, FALLS CHURCH, VA, 22040-0747, US

(21) Appl. No.: 11/979,808

(22) Filed: Nov. 8, 2007

(30) Foreign Application Priority Data
Aug. 13, 2007 (TW) 096129884

(51) Int. Cl. G06F 12/02; G06F 17/00

(52) U.S. Cl. 707/104.1; 711/103; 711/E12.008; 707/E17.101; 707/E17.019

(57) ABSTRACT

A modeling multimedia storage media with playback function and a multimedia player with modeling-looking comprises a housing, a memory for storing multimedia files, and a playback module for playing the multimedia files stored in the memory. The multimedia files stored in the memory are provided in an International Standard Recording Code with respect to the artists, in an International Standard Book Number, or an International Standard Audiovisual Number with respect to the concept of the image.

### BACKGROUND OF THE INVENTION

1. Field of the Invention

The present invention relates to a multimedia storage media and a playback apparatus, and in particular to a multimedia storage media with playback function and a multimedia player with modeling-looking.

2. Description of Related Art

Music, figures, characters, languages, religions etc are usually ideal media to inspire people. Languages, civilization, and lifestyles are used to record history in form of music and totem and exhibit creativity of each race, and they have significant impact on speed of development. People rely on music to comfort themselves or music has a significant effect on therapy.

For example, recording industry. Stage artists or related industry's working groups produce and distribute music, protect intellectual property right, and gain financial yield. In this light, multimedia files such as image files or music files are stored in form of multimedia media. With advent of recording technology, multimedia media are changing. Regarding formats of multimedia media, vinyl records are replaced by vinyl tapes, compact discs or digital compact discs.

At present, multimedia files such as music are recorded or playbacked in digital formats. Various optical disc players can access data stored in 12-inch optical discs or smartphones, and data stored in mp3 format. Digital players which support multimedia data formats are popular with users around the world. For example, iPod is best-selling consumer product of Apple Computer. According to financial results of second quarter of 2007, Apple computer ships 9.815 millions iPod media players. It shows a trend that consumers don't use optical disc players to read 12-inch optical discs. Instead, consumers choose to use digital media players to playback image files or music files.

Intellectual property rights in digitalized file format are helpful in distributing or accessing artistic multimedia files over the internet. Undeniably, the multimedia files are easily copied or distributed over the internet. Even worse, it is likely the multimedia files are copied in bad quality and the intellectual property right is infringed. It has put damage on the artists and related staffs and development of recording industry so as to discourage creativity and contemporary driving forces. Fortunately, quite a few organizations make commitment to preserve advantages of the internet: easy to copy and distribute, and meanwhile, to safeguard rights of artistic works and the artists.

In this light, download mechanism, supervision organization, and copyright protection mechanism for digitalized artistic work files are developed. For example, international organization is responsible for recorded music. The International Standard Recording Code (ISRC) is the international identification system for sound recordings, and each country or publisher presents its ISRC which is a unique and permanent identifier for a specific recording. Thus, it is effective to coordinate enforcement of copyright protection. Regarding to other multimedia data formats, International Standard Book Number (ISBN) represents a collection of songs or International Standard Audiovisual Number (ISAN) identifies works and an audiovisual work regardless of the various formats. Thus, it's effective to coordinate enforcement of copyright protection of various artistic work or audiovisual work or video games.

Furthermore, most users have a concept of copyright protection so it is getting more and more important for users to download digitalized artistic work over the internet. Thumb drives for playbacking files in form of mp3, AAC, WMA, MP4, JPG, AVI, etc formats are becoming best-selling consumer products.

Toy models such as figurines are becoming popular in different industries and are appealing to consumers. Quite a few consumers have a habit of collecting different figurines. Figurien's appearances and creative design are also intellectual property rights and enormous value assets.

Thus, there is a need for a digital multimedia model so as to provide a modeling multimedia storage media with playback function and a multimedia player with modeling-looking.

### SUMMARY OF THE INVENTION

It is an object of the present invention to provide a multimedia storage media with playback function and a multimedia player with modeling-looking. The present invention includes capability of playbacking music, videos, characters or images and is used to protect intellectual property rights and intangible assets.

The present invention relates to a modeling multimedia storage media with playback function and a multimedia player with modeling-looking and includes a housing, a memory and a playback module.

The housing of the present invention has a special appearance, and the memory is used to store at least one multimedia file which corresponds to the special appearance.

The playback module includes a playback application program, an earphone jack, a short distance wireless telecommunication module such as Bluetooth, or a speaker so as to playback the multimedia files stored at the memory through different hardware components.

Thus, the multimedia storage media and the multimedia player of the present invention utilizes the special appearances, virtual animated figures, housings with abstract concept, or copyrighted multimedia files in ISRC format. The present invention does not only have music playbacking but also have special appearances and intellectual property right value.

### BRIEF DESCRIPTION OF THE DRAWINGS

The present invention can be fully understood from the following detailed description and preferred embodiment with reference to the accompanying drawings, in which:

FIG. 1 is a perspective view of a modeling multimedia storage media and a multimedia player of the present invention;

FIGS. 1A-1C are perspective views of three playback modules of the present invention; and

FIG. 2 is a block diagram of a modeling multimedia storage media and a multimedia player of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

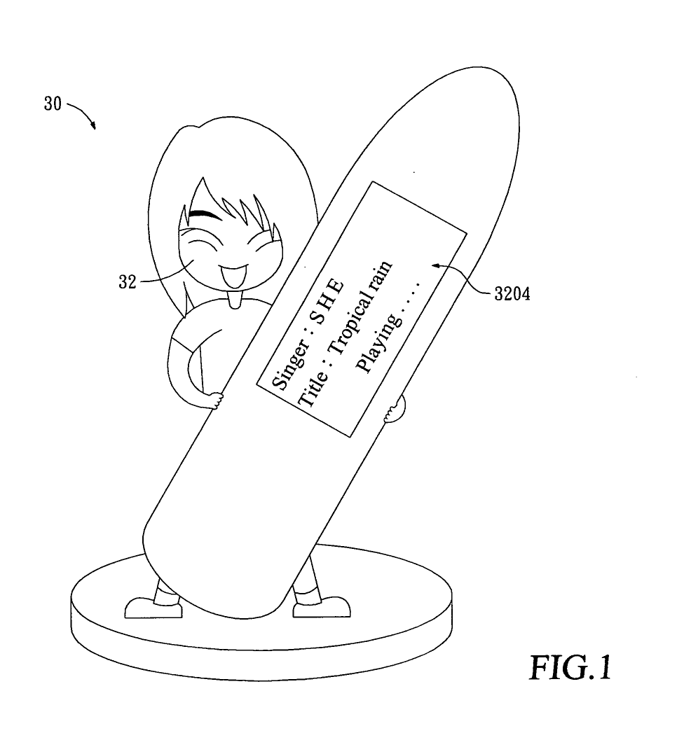

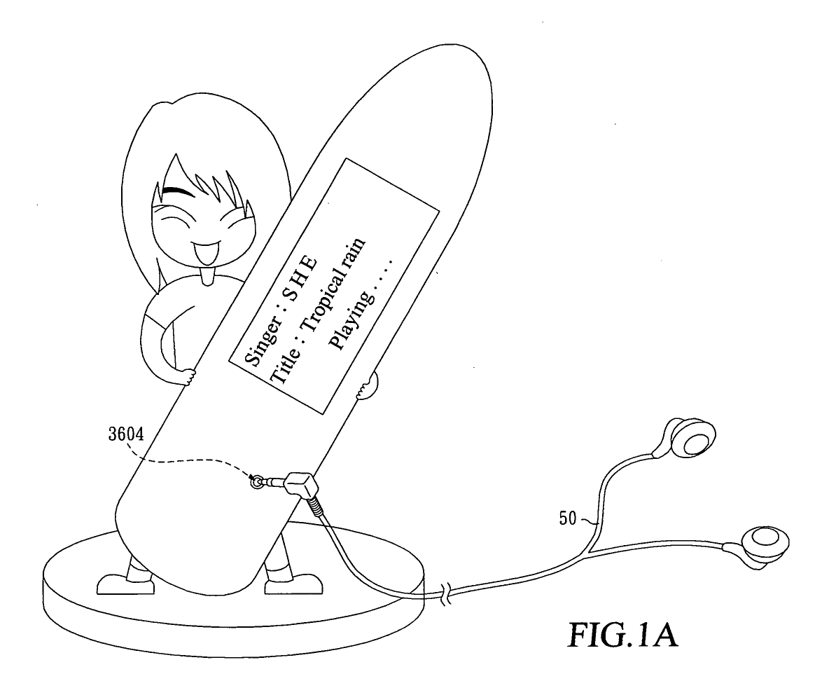

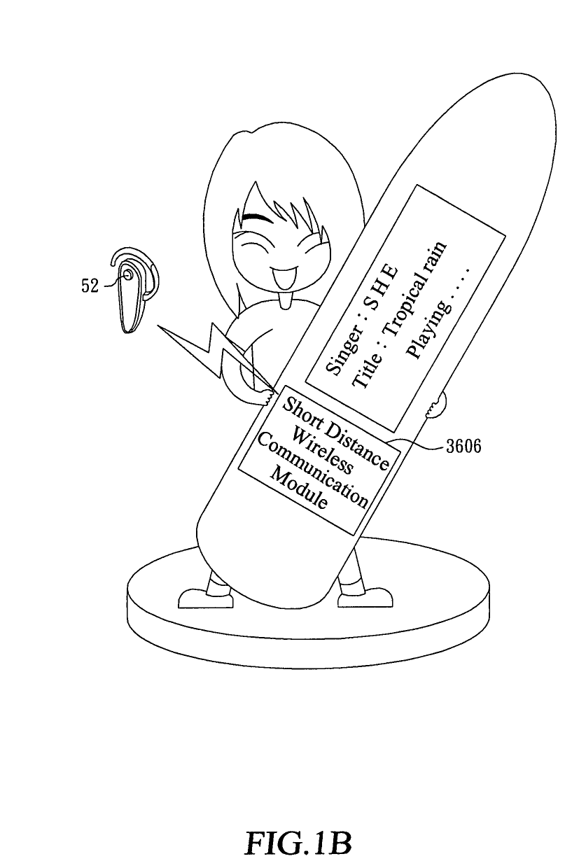

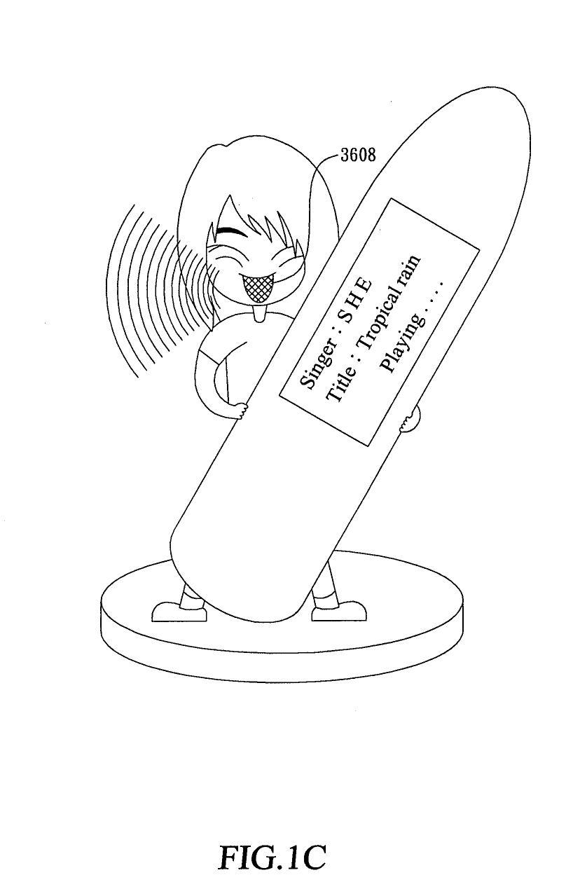

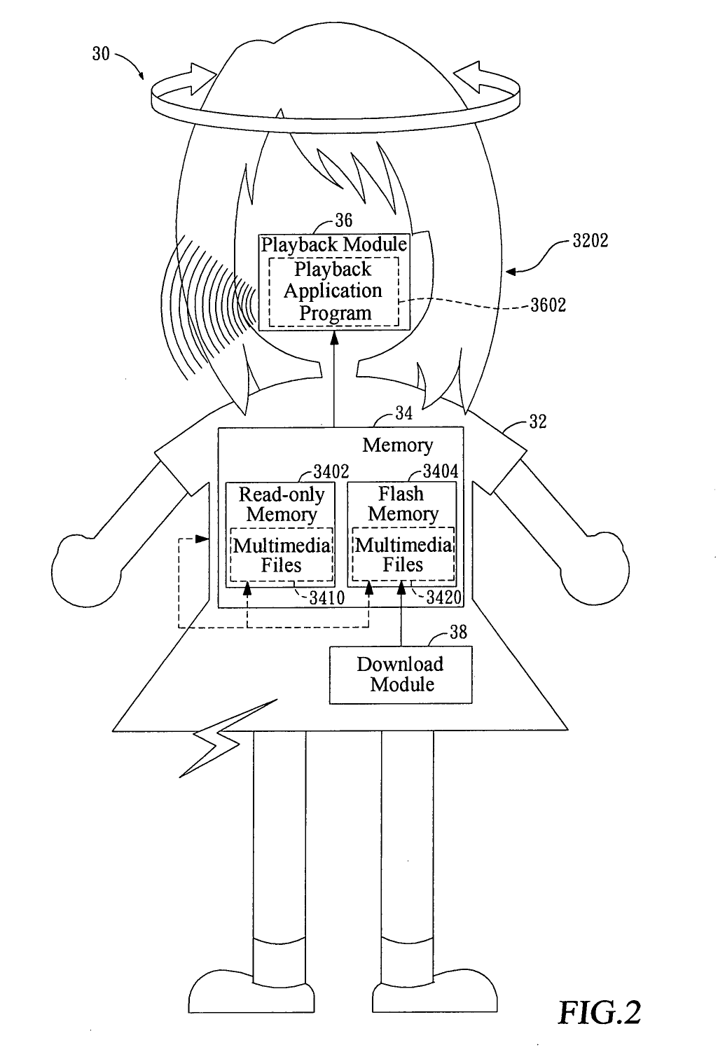

Referring to FIGS. 1 and 2, FIG. 1 illustrates a perspective view of a multimedia storage media 30 and a multimedia player 30 of the present invention. FIG. 2 illustrates a block diagram of a modeling multimedia storage media 30 and a multimedia player 30 of the present invention. The multimedia storage media and multimedia player 30 includes a housing 32, a memory 34 and a playback module 36.

The housing 32 has a special appearance, and the memory 34 is used to store at least one multimedia file 3410 which corresponds to the special appearance.

The special appearance illustrates the artists or virtual animated figures etc, and the special appearance represents multimedia appearance or abstract appearance. The multimedia appearance includes but does not limit to singers, producer, musicians etc. The virtual animated figures includes local famous figurines, and the abstract appearance may represent a music collection and also may represent a complete video/audio media files such as movies, video games or flash files on the internet. The abstract appearance is used to represent an appearance corresponding to the theme or main figures.

The multimedia file 3410 corresponds to the special appearance, and the International Standard Recording Code (ISRC) of the multimedia file 3410 corresponds to the special appearance of the artist. Music recorded by the International Standard Recording Code (ISRC) corresponds to copyright information of multimedia appearance. In addition, the International Standard Audiovisual Number (ISAN) or International Standard Book Number (ISBN) corresponds to abstract appearance of the collection. That is, the International Standard Recording Code (ISRC) of the multimedia file 3410 corresponds to copyright information of the collection or a complete video/audio media files.

Furthermore, each music corresponds to the International Standard Recording Code (ISRC), and in general, the multimedia file 3410 corresponds to a publishing company. According to the present invention, the multimedia file 3410 indirectly corresponds to multimedia appearance. The International Standard Recording Code (ISRC) is 12 characters or Arabia numbers long and includes four parts: country code, registrant code, year of reference element, and designation code in order to facilitate rights management.

Each collection of music corresponds to International Standard Book Number (ISBN). The ISBN is 13-digit long code and consists of four parts: group identifier code, publisher code, item number, and a checksum character in order to facilitate rights management of recorded work.

An audiovisual work corresponds to the International Standard Audiovisual Number (ISAN) which is a 96-bit number code comprised of three segments: a root, an episode or part, and a version. When the 96-bit ISAN is represented in hexadecimal form, it has 24 digits, for example: 000000018947000000000000. However, a printed ISAN designed for human reading always begins with the ISAN label, appears with hyphens to separate the number into several groups of digits, and adds two checksum characters (made up of the letters A-Z) to help identify transcription errors. The resulting number appears as: ISAN 0000-0001-8947-0000-8-0000-0000-D ISAN-IA. It has also developed a recommended practice for encoding the ISAN in a two-dimensional barcode 96 pixels square. Thus, it facilitates copyright management of audiovisual work.

When the ISRC is used to identify the multimedia appearance and a multimedia file 2410, the shape and the appearance of the housing 32 represents specific artists, producers, musicians or singers. When the ISBN is used to identify a collection and a multimedia file 2410, a shape of the collection inherently represents the name of the collection. In addition, the multimedia file 2410 is the collection including several songs. When the ISAN is used to identify the audiovisual work and the multimedia file 2410, the shape of the housing 32 symbolizes the title or the theme of the audiovisual work. The multimedia file 2410 includes soundtracks, images or photos and theme songs.

Further description about the housing 32 is in the following. The housing 32 also includes a playback function key 3202 and a display 3204. The playback function key 3202 is used to manipulate the playback module 36 to playback the multimedia file 3410 or stop playbacking multimedia file 3410. The playback function key 3202 is an independent object and represents a specific appearance. According to the embodiment, the specific appearance symbolizes a singer. The housing 32 is a figurine of the singer, and the head of the figurine is an independent object. Thus, to rotate the head of the figurine is used to manipulate the playback function key 3202 and control functionality of play and stop.

The display 3204 is used to display information corresponding to the multimedia file 3410, and is also used to display current functions. The display 3204 is positioned at the housing 32; and, for example, as shown in FIGS. 1 and 2, the display 3204 is positioned at the surfing board.

The playback module 36 includes software such as a playback application program 3602 and hardware such as a microprocessor. In addition, referring to FIGS. 1A, 1B and 1C, the playback module 36 further includes a earphone jack 3604, a short distance wireless telecommunication module 3606 such as Bluetooth module, or a speaker 3608 so as to playback the multimedia files 3410 stored at the memory 34 through different hardware components.

The playback application program 3602 is a software embed in a chip and is used to access (decode music and image files) and output the multimedia files 3410. In addition, the playback application program 3602 also needs hardware to playback the multimedia files 3410. At present, portable media playback devices are usually compatible with a cord earphone 50, and cordless earphone 52. The cord earphone 50 is much more affordable and the earphone jack 3604 is adapted to connect the cord earphone 50. Thus, music of the multimedia files 3410 is playbacked by the playback application program 3602 and is transmitted to the cord earphone 50.

The cordless earphone 52 can be Bluetooth-compliant or IEEE 802.11-compliant to listen to music. The playback module 36 further includes a short distance wireless communication module 3606 (Bluetooth module, infrared module or IEEE 802.11 module). The short distance wireless communication module 3606 is used to interconnect the cordless earphone 52 so as to transmit the multimedia files 3410 from the playback application program 3602 to the cordless earphone 52.

Furthermore, if volume is not a key factor of design, then the playback module 36 further includes a speaker 3608. The speaker 3608 receives and playbacks the music of the multimedia files 3410 playbacked by the playback application program 3602.

Referring to FIG. 2, the modeling multimedia storage media and a multimedia player 30 further includes a download module 38 used to download multimedia files 3420 from outside source so as to store the multimedia files 3420 at the memory 34.

The download module 38 may download the multimedia files by wireless connection or physical connection. For reasons of easy installation, the download module 38 may be the short distance wireless telecommunication module 3606. If the cordless earphone 52 is utilized, then the short distance wireless telecommunication module 3606 is used to interconnect cordless earphone 52.

The download module 38 may download the multimedia files 3410 which correspond to the specific appearances (includes but is not limited to multimedia appearance or abstract concept) but have not stored at the memory 34 yet. In addition, the memory 34 further includes a read-only memory 3402 and a flash memory 3404.

The multimedia files 3410 corresponding to the specific appearance are stored at the read-only memory 3402 so the multimedia files 3410 won't be deleted. The multimedia files 3410 are protected by individual copyrights (ISRC, ISBN or ISAN). For business purpose, the multimedia files 3410 and the multimedia player 30 are sold together so as to prevent privacy. As described above, the multimedia files 3410 are downloaded from source exterior of the multimedia player 30 and stored at the flash memory 3404 so it is much more flexible for users to use the multimedia player 30.

Because the multimedia player 30 includes the multimedia files 3410 corresponding to the specific appearances (include but are not limited to multimedia appearances or abstract concepts), the multimedia player 30 is a modeling multimedia storage media. It is apparent that the multimedia player 30 is similar to an artist's collection and users may collect the multimedia player 30 because of artist's portrait. In addition to functionality of music playbacking, the multimedia player 30 has intellectual property right such as copyright. The multimedia player 30 is not only a collection of music but also is used to prevent privacy.

Furthermore, the multimedia player 30 is a portable device, so users enjoy the audiovisual works anywhere. Thus, the multimedia player 30 is powered by batteries which is rechargeable or is not. At present, the battery may be charged through USB ports.

Thus, the modeling multimedia storage media 30 and a multimedia player 30 of the present invention utilizes special appearances, virtual animated figures, housings with abstract concept, or copyrighted multimedia files 3410. The present invention does not only have music playbacking but also have special appearances and intellectual property right value.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A modeling multimedia storage media with playback function, comprising:
a housing, having a special appearance;
a memory, used to store at least one multimedia file which corresponds to the special appearance; and
a playback module, used to playback the multimedia files stored at the memory.

2. The modeling multimedia storage media as claimed in claim 1, wherein the special appearance represents a multimedia artist, the multimedia file corresponds to the special appearance, and the International Standard Recording Code (ISRC) of the multimedia file corresponds to the multimedia artist.

3. The modeling multimedia storage media as claimed in claim 1, wherein the special appearance represents a collection abstract appearance, the multimedia file corresponds to the collection abstract appearance, and the International Standard Book Number (ISBN) of the multimedia file corresponds to the collection abstract appearance.

4. The modeling multimedia storage media as claimed in claim 1, wherein the special appearance represents a collection abstract appearance, the multimedia file corresponds to the collection abstract appearance, and the International Standard Audiovisual Number (ISAN) of the multimedia file corresponds to the collection abstract appearance.

5. The modeling multimedia storage media as claimed in claim 1, wherein the housing includes at least one playback function key so that the playback module is manipulated to playback the multimedia file.

6. The modeling multimedia storage media as claimed in claim 5, wherein the display is used to display information corresponding to the multimedia files.

7. The modeling multimedia storage media as claimed in claim 1, wherein the playback module includes a pre-installed playback application program which is used to access and output the multimedia files.

8. The modeling multimedia storage media as claimed in claim 7, wherein the playback module further includes a earphone jack, and the earphone jack is used to connect exterior earphone so that music of the multimedia files playbacked by the playback application program is transmitted to the exterior earphone.

9. The modeling multimedia storage media as claimed in claim 7, wherein the playback module further includes a short distance wireless telecommunication module which is used to interconnect an exterior wireless earphone so that music of the multimedia files playbacked by the playback application program is transmitted to the exterior wireless earphone.

10. The modeling multimedia storage media as claimed in claim 1, wherein the multimedia player further includes a download module which is used to download the multimedia files from exterior of the multimedia player so that the multimedia files is stored at the memory.

11. The modeling multimedia storage media as claimed in claim 10, wherein the memory further includes a read-only memory and a flash memory, and the multimedia files corresponding to the specific appearance are stored at the read-only memory and the multimedia files are downloaded from exterior of the multimedia player and stored at the flash memory.

12. A playback apparatus with modeling-looking, comprising:
a housing, having a special appearance;
a memory, used to store at least one multimedia file which corresponds to the special appearance; and
a playback module, used to playback the multimedia files stored at the memory.

13. The playback apparatus as claimed in claim 12, wherein the special appearance represents a multimedia artist, the multimedia file corresponds to the special appearance, and the International Standard Recording Code (ISRC) of the multimedia file corresponds to the multimedia artist.

14. The playback apparatus as claimed in claim 12, wherein the special appearance represents a collection abstract appearance, the multimedia file corresponds to the collection abstract appearance, and the International Standard Book Number (ISBN) of the multimedia file corresponds to the collection abstract appearance.

15. The playback apparatus as claimed in claim 12, wherein the special appearance represents a collection abstract appearance, the multimedia file corresponds to the collection abstract appearance, and the International Standard Audiovisual Number (ISAN) of the multimedia file corresponds to the collection abstract appearance.

16. The playback apparatus as claimed in claim 12, wherein the housing includes at least one playback function key so that the playback module is manipulated to playback the multimedia file.

17. The playback apparatus as claimed in claim 16, wherein the display is used to display information corresponding to the multimedia files.

18. The playback apparatus as claimed in claim 16, wherein the playback module includes a pre-installed playback application program which is used to access and output the multimedia files.

19. The playback apparatus as claimed in claim 18, wherein the playback module further includes a earphone jack, and the earphone jack is used to connect exterior earphone so that music of the multimedia files playbacked by the playback application program is transmitted to the exterior earphone.

20. The playback apparatus as claimed in claim 18, wherein the playback module further includes a short distance wireless telecommunication module which is used to interconnect an exterior wireless earphone so that music of the multimedia files playbacked by the playback application program is transmitted to the exterior wireless earphone.

21. The playback apparatus as claimed in claim 12, wherein the multimedia player further includes a download module which is used to download the multimedia files from exterior of the multimedia player so that the multimedia files is stored at the memory.

22. The playback apparatus as claimed in claim 12, wherein the memory further includes a read-only memory and a flash memory, and the multimedia files corresponding to the specific appearance are stored at the read-only memory and the multimedia files are downloaded from exterior of the multimedia player and stored at the flash memory.
